(19) United States
(12) Patent Application Publication
(10) Pub. No.: US 2017/0186454 A1
(43) Pub. Date: Jun. 29, 2017

(54) HEAD POSITION DETECTING METHOD AND MAGNETIC DISK DEVICE

(71) Applicant: Kabushiki Kaisha Toshiba, Tokyo (JP)

(72) Inventors: Makoto Asakura, Bunkyo Tokyo (JP); Naoki Tagami, Yokohama (JP)

(21) Appl. No.: 15/057,366

(22) Filed: Mar. 1, 2016

Related U.S. Application Data
(60) Provisional application No. 62/272,381, filed on Dec. 29, 2015.

(51) Int. Cl. G11B 5/596; G11B 20/10

(52) U.S. Cl. CPC G11B 5/59627; G11B 5/59688; G11B 20/10305

(57) ABSTRACT

According to one embodiment, a magnetic head reads burst patterns arranged on a magnetic disk in a down-track direction such that phases in a cross-track direction are different from each other while moving over the burst patterns, a burst value is generated from the results of reading of the burst patterns by the magnetic head, and a noise component appearing in the burst value resulting from a magnetic field applied in the cross-track direction at the time of reading of the burst patterns is corrected.

### CROSS-REFERENCE TO RELATED APPLICATIONS

This application is based upon and claims the benefit of priority from U.S. Provisional Application No. 62/272,381, filed on Dec. 29, 2015; the entire contents of which are incorporated herein by reference.

### FIELD

Embodiments described herein relate generally to a head position detecting method and a magnetic disk device.

### BACKGROUND

In a magnetic disk device, sector cylinder numbers in servo data and burst values indicative of position information on tracks are taken and a magnetic head is positioned based on the information.

### BRIEF DESCRIPTION OF THE DRAWINGS

FIG. 1 is a schematic block diagram of a magnetic disk device according to a first embodiment;

FIG. 2A is a planar view of a track arrangement on a magnetic disk illustrated in FIG. 1, and FIG. 2B is a diagram illustrating a configuration example of a servo area illustrated in FIG. 2A;

FIG. 3 is a schematic block diagram of a position detection processing unit illustrated in FIG. 1;

FIG. 4 is a schematic block diagram of a head bias correction unit illustrated in FIG. 3;

FIG. 5A is a planar view illustrating a configuration example of burst patterns illustrated in FIG. 2B, FIG. 5B is a diagram illustrating a signal amplitude waveform obtained by a read head HR when the read head HR passes through a path TE illustrated in FIG. 5A, FIG. 5C is a cross-sectional view illustrating a configuration example of the read head HR illustrated in FIG. 5A, FIG. 5D is an enlarged planar view of an area NA illustrated in FIG. 5A, and FIG. 5E is an enlarged planar view of an area QA illustrated in FIG. 5A;

FIG. 6 is a diagram illustrating the relationships between hard bias and magnetic resistance of the magnetic disk device according to the first embodiment;

FIG. 7A is a diagram illustrating the relationship between off-track amount and burst error of the magnetic disk device according to the first embodiment, FIG. 7B is a diagram illustrating the relationship between actual position and detection error of the read head HR of the magnetic disk device according to the first embodiment, FIG. 7C is a diagram illustrating a position Lissajous figure of N-phase component and Q-phase component before bias correction of DFT arithmetic operation results of head output in the magnetic disk device according to the first embodiment, and FIG. 7D is a diagram illustrating a position Lissajous figure of N-phase component and Q-phase component after bias correction of DFT arithmetic operation results of head output in the magnetic disk device according to the first embodiment;

FIG. 8 is a flowchart of a servo interrupt process in the magnetic disk device according to the first embodiment;

FIG. 9A is a diagram illustrating the relationship between off-track amount and burst error of a magnetic disk device according to a second embodiment, and FIG. 9B is a diagram illustrating the relationship between actual position and detection error of the read head HR of the magnetic disk device according to the second embodiment;

FIG. 10A is a diagram illustrating the relationship between off-track amount and burst error of a magnetic disk device according to a third embodiment, FIG. 10B is a diagram illustrating the relationship between actual position and detection error of the read head HR of the magnetic disk device according to the third embodiment, and FIG. 10C is a diagram illustrating a position Lissajous figure of N-phase component and Q-phase component after bias correction of DFT arithmetic operation results of head output in the magnetic disk device according to the third embodiment;

FIG. 11A is a diagram illustrating the relationship between off-track amount and burst error of a magnetic disk device according to a fourth embodiment, FIG. 11B is a diagram illustrating the relationship between actual position and detection error of the read head HR of the magnetic disk device according to the fourth embodiment, FIG. 11C is a diagram illustrating a position Lissajous figure of N-phase component and Q-phase component after bias correction of DFT arithmetic operation results of head output in the magnetic disk device according to the fourth embodiment, and FIG. 11D is a diagram illustrating a position Lissajous figure of N-phase component and Q-phase component after bias correction and rotation correction of DFT arithmetic operation results of head output in the magnetic disk device according to the fourth embodiment;

FIG. 12A is a diagram illustrating the relationship between tracking position and burst value applied to a bias offset identification process in a magnetic disk device according to a fifth embodiment, and FIG. 12B is a diagram illustrating the relationship between tracking position and burst error identified by the bias off-set identification process in the magnetic disk device according to the fifth embodiment;

FIG. 13 is a flowchart of the bias offset identification process in the magnetic disk device according to the fifth embodiment;

FIG. 14 is a schematic block diagram of a head bias correction unit of a magnetic disk device according to a sixth embodiment;

FIG. 15A is a diagram illustrating the relationship between off-track amount and burst gain of the magnetic disk device according to the sixth embodiment, FIG. 15B is a diagram illustrating the relationship between actual position and detection error of the read head HR of the magnetic disk device according to the sixth embodiment, FIG. 15C is a diagram illustrating a position Lissajous figure of N-phase component and Q-phase component after bias correction of DFT arithmetic operation results of head output in the magnetic disk device according to the sixth embodiment, and FIG. 15D is a diagram illustrating a position Lissajous figure of N-phase component and Q-phase component after adjustment of optimum coefficients at the time of bias correction of DFT arithmetic operation results of head output in the magnetic disk device according to the sixth embodiment;

FIG. 16 is a schematic block diagram of a position detection processing unit of a magnetic disk device according to a seventh embodiment;

FIG. 17 is a schematic block diagram of a head bias correction unit illustrated in FIG. 16;

FIG. 18A is a diagram illustrating the relationship between off-track amount and burst error of the magnetic disk device according to the seventh embodiment, FIG. 18B is a diagram illustrating the relationship between actual position and detection error of the read head HR of the magnetic disk device according to the seventh embodiment, and FIG. 18C is a diagram illustrating a position Lissajous figure of N-phase component and Q-phase component after bias correction of DFT arithmetic operation results of head output in the magnetic disk device according to the seventh embodiment; and

FIG. 19 is a flowchart of a servo interrupt process in the magnetic disk device according to the seventh embodiment.

### DETAILED DESCRIPTION

In general, according to one embodiment, a magnetic head moves over burst patterns arranged on a magnetic disk in a down-track direction such that phases in a cross-track direction are different from each other and reads the burst patterns, burst values are produced from the results of reading of the burst patterns by the magnetic head, and noise components appearing on the burst values resulting from a magnetic field applied in the cross-track direction at the time of reading of the burst patterns are corrected.

Exemplary embodiments of a head position detecting method and a magnetic disk device will be explained below in detail with reference to the accompanying drawings. The present invention is not limited to the following embodiments.

### First Embodiment

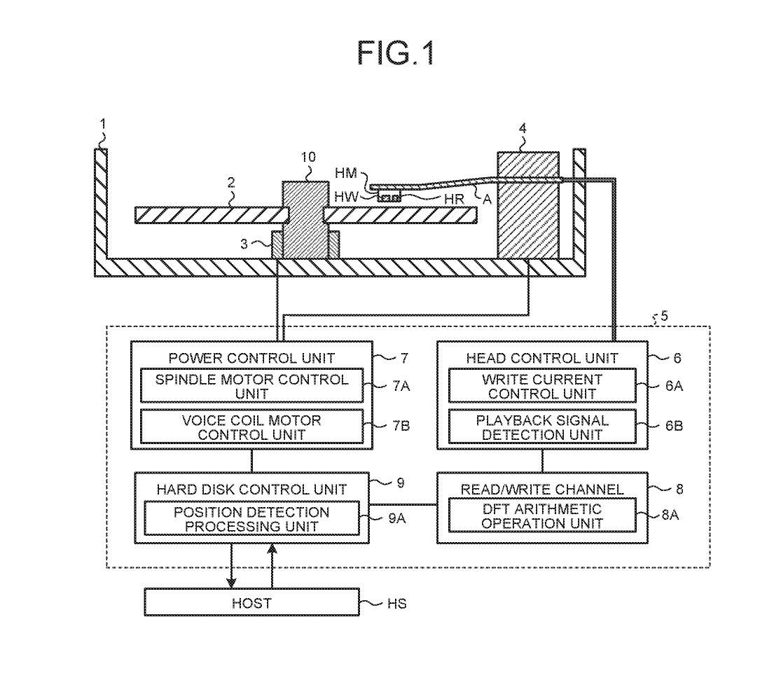

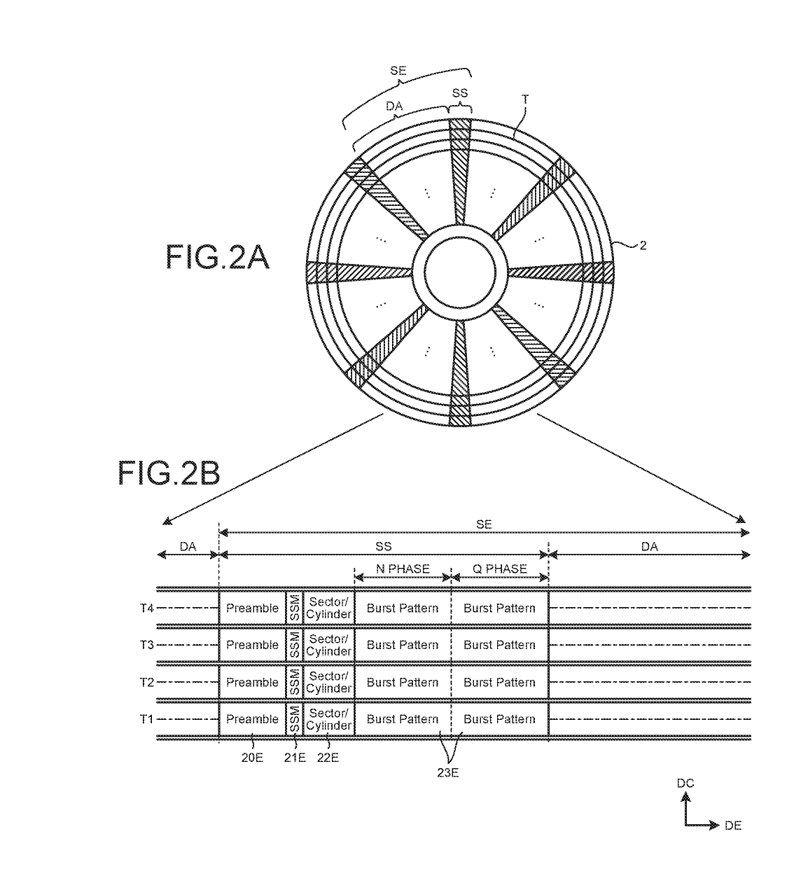

FIG. 1 is a schematic block diagram of a magnetic disk device according to a first embodiment, FIG. 2A is a planar view of a track arrangement on a magnetic disk illustrated in FIG. 1, and FIG. 2B is a diagram illustrating a configuration example of a servo area illustrated in FIG. 2A.

Referring to FIG. 1, the magnetic disk device is provided with a magnetic disk 2 supported via a spindle 10. The magnetic disk device is also provided with a head slider HM. The head slider HM is provided with a write head HW and a read head HR as magnetic heads. The write head HW and the read head HR are opposed to the magnetic disk 2. The head slider HM is held above the magnetic disk 2 via an arm A. The arm A can slide the head slider HM in a horizontal plane at the seek time or the like.

As illustrated in FIGS. 2A and 2B, the magnetic disk 2 is provided with X (X denotes an integer of 2 or more) tracks T along a down-track direction (also called circumferential direction) DE. The tracks T are provided with data areas DA in which user data is to be written and servo areas SS in which servo data is written. The servo areas SS are radially arranged, and the data areas DA are arranged between the servo areas SS in the down-track direction DE. The servo areas SS can be divided radially into equal M (M denotes an integer of 2 or more) parts. The servo areas SS divided into equal M parts and the data areas DA constitute sectors SE.

The servo areas SS record preambles 20E, servo marks 21E, sector/cylinder information (gray codes) 22E, and burst patterns 23E. The servo marks 21E can indicate the beginnings of the servo areas SS on the tracks T. The sector/cylinder information 22E can provide circumferential and radial servo addresses (also called address information) on the magnetic disk 2. As the circumferential servo addresses, values 0 to M−1 can be given sequentially to the individual sectors SE divided into equal M parts. As the radial servo addresses, values 0 to X−1 can be given sequentially to the individual X tracks T.

The burst patterns 23E can be phase patterns with N and Q phases. The magnetization patterns can be arranged in the down-track direction DE such that the N and Q phases are alternate in a cross-track direction DC (also called radial direction). Specifically, the magnetization patterns of N and Q phases can be arranged such that the polarities are alternately reversed at 180-degree phase intervals in the cross-track direction DC. The N and Q phases are shifted from each other 90 degrees in the cross-track direction DC. For example, the N phase can be arranged such that the polarities are reversed at boundaries between the adjacent tracks T1 to T4, and the Q phase can be arranged such that the polarities are reversed at the centers of the tracks T1 to T4. The sector/cylinder information 22E and the burst patterns 23E can be used for a seek control under which the write head HW and the read head HR are moved to a target track and a target sector. The sector/cylinder information 22E and the burst patterns 23E can also be used for a tracking control under which the write head HW and the read head HR are positioned within a track width of a target track.

Returning to FIG. 1, the magnetic disk device is provided with a voice coil motor 4 that drives the arm A and a spindle motor 3 that rotates the magnetic disk 2. The magnetic disk 2, the head slider HM, the arm A, the voice coil motor 4, and the spindle motor 3 are housed in a case 1.

The magnetic disk device is also provided with a data control unit 5. The data control unit 5 is provided with a head control unit 6, a power control unit 7, a read/write channel 8, and a hard disk control unit 9. The data control unit 5 can control the positions of the write head HW and the read head HR based on the servo data read by the read head HR.

The head control unit 6 is provided with a write current control unit 6A and a playback signal detection unit 6B. The power control unit 7 is provided with a spindle motor control unit 7A and a voice coil motor control unit 7B. The read/write channel 8 is provided with a DFT (Discrete Fourier Transform) operation unit 8A. The hard disk control unit 9 is provided with a position detection processing unit 9A.

The head control unit 6 can amplify or detect a signal at the time of recording and playback. The write current control unit 6A can control write current flowing into the write head HW. The playback signal detection unit 6B can detect a signal read by the read head HR.

The power control unit 7 can drive the voice coil motor 4 and the spindle motor 3. The spindle motor control unit 7A can control the rotation of the spindle motor 3. The voice coil motor control unit 7B can control the driving of the voice coil motor 4.

The read/write channel 8 can exchange data with the head control unit 6 and the hard disk control unit 9. The data may be read data, write data, and servo data. For example, the read/write channel 8 can convert a signal replayed by the read head HR into a data format to be treated by a host HS, and can convert the data output from the host HS into a signal format to be recorded in the write head HW. The format conversion may be DA conversion or encoding. The read/write channel 8 can decode the signal replayed by the read head HR, and can perform code modulation of the data output from the host HS. The DFT arithmetic operation unit 8A can perform a DFT arithmetic operation of a signal obtained by the read head HR reading the burst patterns 23E and extract fundamental wave components from the signal. The fundamental wave component can be sin components or cos components in the N and Q phases of the burst patterns 23E.

In the foregoing description, a curve obtained by representing on a phase plane the relationship between the sin component and cos component in the N phase of the burst pattern 23 or the relationship between the sin component and cos component in the Q phase of the burst pattern 23 will be referred to as complex Lissajous figure. The complex Lissajous figure is a drawing of a real part (cos component) and an imaginary part (sin component) of the fundamental wave components of the burst patterns 23E read by the read head HR. In addition, a curve obtained by subjecting the sin component and the cos component in the N phase and the sin component and the cos component in the Q phase of the burst patterns 23E to composite operation and representing on a phase plane the relationship between the N-phase components and the Q-phase components at that time will be referred to as position Lissajous figure.

The hard disk control unit 9 can perform a recording and playback control based on a command from the outside or exchange data with the outside and the read/write channel 8. The position detection processing unit 9A can detect the positions of the write head HW and the read head HR based on the servo data read by the read head HR. The hard disk control unit 9 may be provided with a general-purpose processor performing a recording playback control and a dedicated processor exchanging data with the host HS and the read/write channel 8. The position detection processing unit 9A can be implemented by firmware executed by the general-purpose processor.

The data control unit 5 is connected to the host HS. The host HS may be a personal computer issuing a write command, a read command, and the like to the magnetic disk device or may be an external interface.

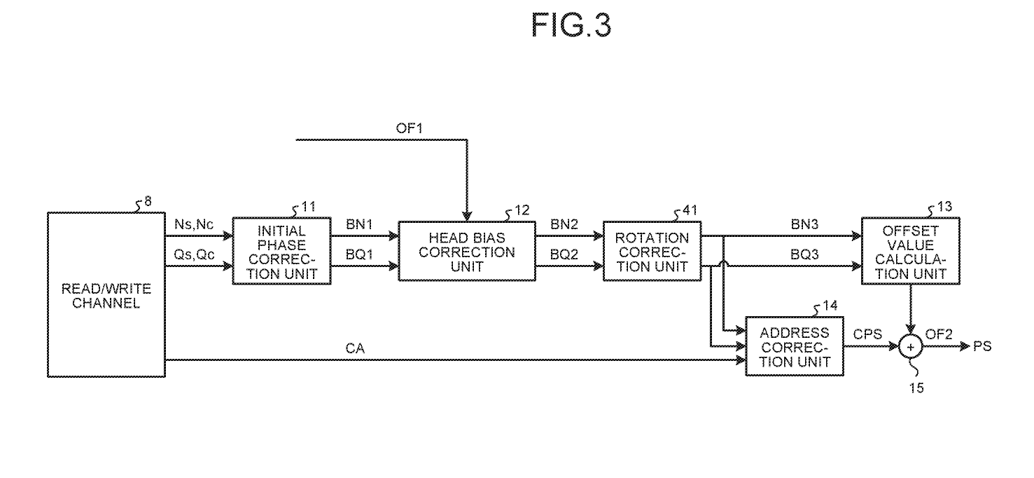

FIG. 3 is a schematic block diagram of the position detection processing unit illustrated in FIG. 1.

Referring to FIG. 3, the position detection processing unit 9A is provided with an initial phase correction unit 11, a head bias correction unit 12, a rotation correction unit 41, an offset value calculation unit 13, an address correction unit 14, and an adder 15. The initial phase correction unit 11 corrects a phase shift in a burst gate relative to the burst patterns 23E. The head bias correction unit 12 corrects a burst value obtained from the result of reading of the burst patterns 23E by the read head HR. At this time, the head bias correction unit 12 can correct a noise component appearing in the burst value resulting from a magnetic field applied in the cross-track direction DC at the time of reading of the burst patterns 23E. The noise component may be called anti-parallel noise because it results from an asymmetric magnetic field in the cross-track direction DC. The correction of the burst value can be independently executed for the N-phase components and the Q-phase components of the burst patterns 23E. The rotation correction unit 41 rotates a position Lissajous figure of the N-phase components and the Q-phase components of the burst value corrected by the head bias correction unit 12. The offset value calculation unit 13 calculates an offset value based on the burst value obtained from the position Lissajous figure rotated by the rotation correction unit 41. The address correction unit 14 corrects the read value of the cylinder address based on the burst value obtained from the position Lissajous figure rotated by the rotation correction unit 41. The adder 15 adds up the offset value calculated by the offset value calculation unit 13 and the cylinder address corrected by the address correction unit 14.

The operations of the magnetic disk device illustrated in FIG. 1 will be described with reference to FIGS. 1 to 3. In the following description, the position Lissajous figure is calculated based on the real parts (cos components) in the N and Q phases of the burst patterns 23E, for example.

While the magnetic disk 2 is rotated by the spindle motor 3, a signal is read from the magnetic disk 2 via the read head HR and detected by the playback signal detection unit 6B. The signal detected by the playback signal detection unit 6B is subjected to data conversion by the read/write channel 8 and sent to the hard disk control unit 9. At this time, the DFT arithmetic operation unit 8A performs a DFT arithmetic operation of the signal obtained by reading the burst patterns 23E by the read head HR at a burst frequency. Then, a sin component Ns and a cos component Nc in the N phase and a sin component Qs and a cos component Qc in the Q phase of the burst patterns 23E are extracted.

Next, the initial phase correction unit 11 rotates the complex Lissajous figure by a predetermined angle to decrease the inclination of a long axis of the complex Lissajous figure in the N phase and the Q phase of the burst patterns 23E. The sin component Ns and the cos component Nc in the N phase and the sin component Qs and the cos component Qc in the Q phase are subjected to composite operation to calculate an N-phase component BN1 and a Q-phase component BQ1 of the burst value. The N-phase component BN1 and the Q-phase component BQ1 of the burst value are obtained by converting the results of the DFT arithmetic operation of the burst patterns 23E into values equivalent to amplitudes with polarity signs.

Next, the head bias correction unit 12 corrects independently noise components appearing in the N-phase component BN1 and the Q-phase component BQ1 resulting from a magnetic field applied to the read head HR in the cross-track direction DC at the time of reading of the burst patterns 23E, thereby to produce an N-phase component BN2 and a Q-phase component BQ2 of the burst value. At this time, in the N-phase component BN2 and the Q-phase component BQ2 of the burst value, the noise components appearing in the N-phase component BN1 and the Q-phase component BQ1 of the burst value resulting from the magnetic field applied in the cross-track direction DC at the time of reading of the burst patterns 23E can be reduced.

The magnetic field applied to the read head HR in the cross-track direction DC at the time of reading of the burst patterns 23E varies depending on a current offset value OF1 of the read head HR. The offset value OF1 is a current position gap of the read head HR from the center of the burst patterns 23E in the cross-track direction DC. Accordingly, based on the offset value OF1, the noise components appearing in the N-phase component BN1 and the Q-phase component BQ1 of the burst value can be independently corrected. However, the current position gap of the read head HR from the center of the burst patterns 23E in the cross-track direction DC is not correctly known. Accordingly, a target offset value BF can be used as the offset value OF1, for example.

Next, the rotation correction unit 41 rotates the position Lissajous figure of the N-phase component BN2 and the Q-phase component BQ2 of the burst value corrected by the head bias correction unit 12 to produce an N-phase component BN3 and a Q-phase component BQ3 of the burst value. At this time, the position Lissajous figure can be rotated to reduce the inclination of the position Lissajous figure deformed in a rectangular shape at the time of reading of the burst patterns 23E by the read head HR.

Next, the offset value calculation unit 13 calculates an offset value OF2 based on the N-phase component BN3 and the Q-phase component BQ3 of the burst value. The offset value OF2 is a position gap of the read head HR from the center of the burst patterns 23E in the cross-track direction DC.

The read/write channel 8 also outputs a cylinder address value CA read by the read head HR to the address correction unit 14. The address correction unit 14 corrects the cylinder address value CA based on the N-phase component BN3 and the Q-phase component BQ3 of the burst value to produce cylinder position information CPS. At the correction of the cylinder address value CA, when the read head HR moves in the down-track direction DE near the boundary in the sector/cylinder information 22E illustrated in FIG. 2B, a misreading of parity of the cylinder address can be corrected. That is, the cylinder address value CA read by the read head HR can be corrected by ±1 such that, assuming that the cylinder address read at the position determined from the off-track amount of the read head HR is correct, the parity of the cylinder address value CA read by the read head HR coincides with the parity of the cylinder address determined as correct. By the correction of the cylinder address value CA, it is possible to prevent occurrence of discontinuous skips in the head position information PS. The adder 15 adds up the offset value OF2 calculated by the offset value calculation unit 13 and the cylinder position information CPS to produce head position information PS.

When a magnetic field is applied to the read head HR in the cross-track direction DC at the time of reading of the burst patterns 23E, noise appears in the results of reading of the burst patterns 23E for use in the detection of the current position of the read head HR. At this time, by correcting the noise components appearing in the N-phase component BN1 and the Q-phase component BQ1 of the burst value resulting from the magnetic field applied to the read head HR in the cross-track direction DC at the time of reading of the burst patterns 23E, it is possible to decrease noise as detection error of the current position of the read head HR and improve the detection accuracy of the current position of the read head HR.

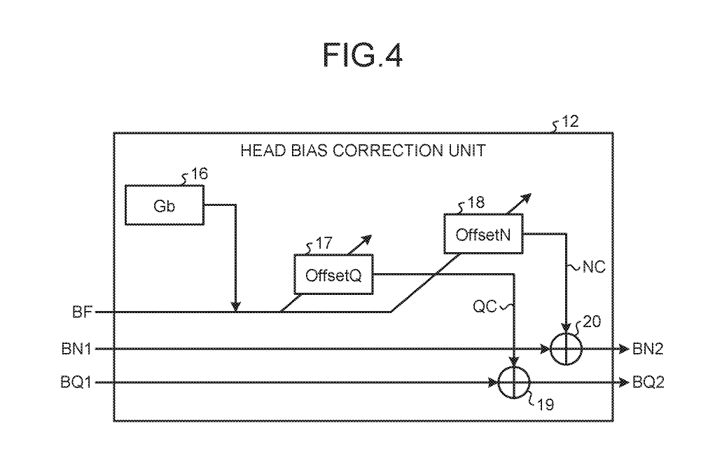

FIG. 4 is a schematic block diagram of the head bias correction unit illustrated in FIG. 3.

Referring to FIG. 4, the head bias correction unit 12 is provided with a coefficient output unit 16, correction value calculation units 17 and 18, and adders 19 and 20. The correction value calculation unit 17 calculates a correction value QC of the Q-phase component BQ1 from the target offset value BF. The correction value QC can be calculated with reference to the relationship between the off-track amount of the read head HR and the burst error of the Q-phase component BQ1 (hereinafter, the relationship will be referred to as Q-phase noise pattern). The relationship may be registered in a table or may be given by an arithmetic equation. At this time, the Q-phase noise pattern can be approximated to the noise component appearing in the Q-phase component BQ1 of the burst value. The off-track amount of the read head HR is a current position gap of the read head HR from the center of the track in the cross-track direction DC. The correction value calculation unit 18 calculates a correction value NC of the N-phase component BN1 from the target offset value BF. The correction value NC can be calculated with reference to the relationship between the off-track amount of the read head HR and the burst error of the N-phase component BN1 (hereinafter, the relationship will be referred to as N-phase noise pattern). The relationship may be registered in a table or may be given by an arithmetic equation. At this time, the N-phase noise pattern can be approximated to the noise component appearing in the N-phase component BN1 of the burst value. The coefficient output unit 16 outputs optimization coefficients Gb for optimization of the correction values QC and NC. The optimization coefficients Gb can be set at optimum values for each read head HR. The adder 19 adds the correction value QC to the Q-phase component BQ1. The adder 20 adds the correction value NC to the N-phase component BN1.

The correction value calculation unit 17 refers to the Q-phase noise pattern to determine the burst error of the Q-phase component BQ1 corresponding to the target offset value BF. Then, the correction value calculation unit 17 multiplies the burst error by the optimization coefficient Gb to calculate the correction value QC of the Q-phase component BQ1. The adder 19 adds the correction value QC to the Q-phase component BQ1 to calculate the Q-phase component BQ2.

The correction value calculation unit 18 refers to the N-phase noise pattern to determine the burst error of the N-phase component BN1 corresponding to the target offset value BF. Then, the correction value calculation unit 18 multiplies the burst error by the optimization coefficient Gb to calculate the correction value NC of the N-phase component BN1. The adder 20 adds the correction value NC to the N-phase component BN1 to calculate the N-phase component BN2.

By using the target offset value BF as the offset value OF1 illustrated in FIG. 3, the correction values QC and NC can be determined without having to determine the offset value OF2. This improves the calculation accuracy of the offset value OF2 while suppressing the increase in the scale of the head bias correction unit 12.

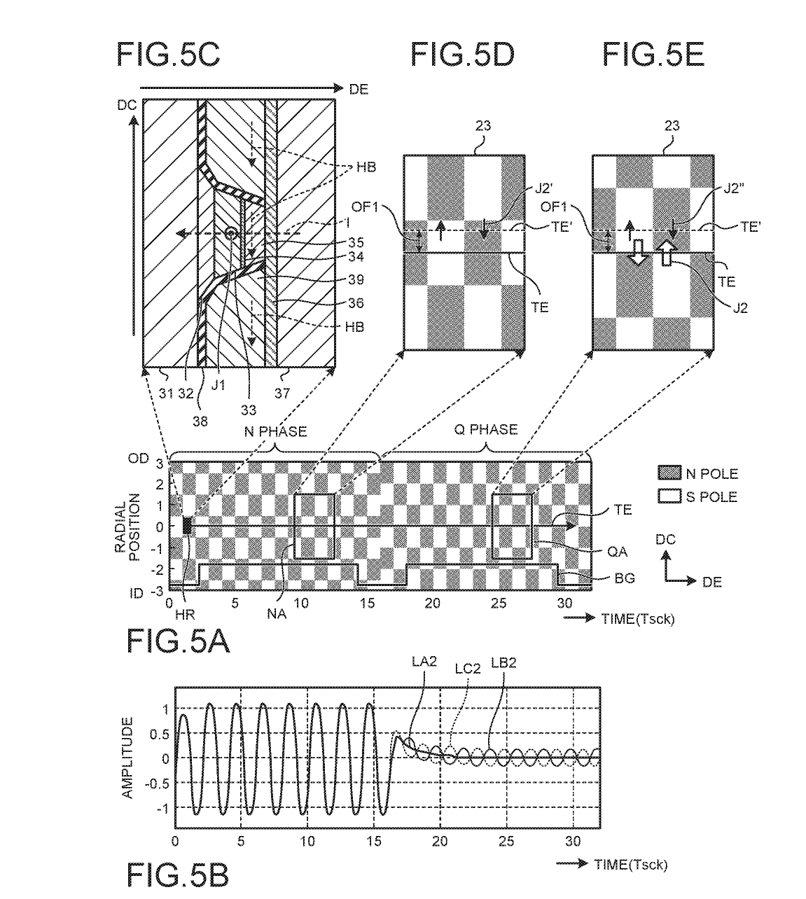

FIG. 5A is a planar view illustrating a configuration example of the burst patterns illustrated in FIG. 2B, FIG. 5B is a diagram illustrating a signal amplitude waveform obtained by the read head HR when the read head HR passes through a path TE illustrated in FIG. 5A, FIG. 5C is a cross-sectional view illustrating a configuration example of the read head HR illustrated in FIG. 5A, FIG. 5D is an enlarged planar view of an area NA illustrated in FIG. 5A, and FIG. 5E is an enlarged planar view of an area QA illustrated in FIG. 5A. FIG. 5A illustrates a configuration of the burst patterns 23E for six tracks arranged from an outer peripheral side OD to a central side ID of the magnetic disk 1 as an example. In FIGS. 5A and 5B, the lateral axis indicates sampling time (Tsck). In FIG. 5B, LA2 indicates a waveform with a hard bias HB of 0, LB2 indicates a waveform with a hard bias HB of positive values, and LC2 indicates a waveform with a hard bias HB of negative values. In the example of FIG. 5C, the read head HR is a magnetic resistive element using GMR (Giant Magneto Resistive effect). Alternatively, the read head HR may be a magnetic resistive element using TMR (Tunnel Magneto Resistance Effect).

Referring to FIG. 5A, the N phase is arranged such that the polarity is reversed at the boundaries between radial positons −3 to 3, and the Q phase is arranged such that the polarity is reversed at the centers of the radial positions −3 to 3. When the read head HR is to read the burst patterns 23E, a burst gate BG is set for the burst patterns 23E. The initial phase correction unit 11 can rotate the complex Lissajous figure of the burst patterns 23E by a predetermined angle to correct a phase shift of the burst gate relative to the burst patterns 23E.

Referring to FIG. 5C, the read head HR is provided with a pin layer 33, a barrier layer 34, and a free layer 35. The pin layer 33 and the free layer 35 can be magnetic layers, and the barrier layer 34 can be a non-magnetic layer. The pin layer 33 can fix a magnetic spin direction. The free layer 35 can change the magnetic spin direction.

In the down-track direction DE, a bottom shield 31 is provided on the back side of the pin layer 33 via a metal gap 32. In the down-track direction DE, a top shield 37 is provided at the front side of the free layer 35 via a metal gap 36. The bottom shield 31 and the top shield 37 can prevent a leaked magnetic field from the burst patterns 23E in the down-track direction DE from being applied to the free layer 35. In the cross-track direction DC, a bias material 39 is provided on both sides of the pin layer 33, the barrier layer 34, and the free layer 35 via an insulator 38. The bias material 39 can apply a hard bias HB as a certain magnetic field in the cross-track direction DC to the free layer 35.

When a vertical magnetic field J1 from the burst patterns 23E is applied to the free layer 35, the spin direction of the free layer 35 changes depending on the vertical magnetic field J1. At this time, even the vertical magnetic field J1 is applied to the pin layer 33, the spin direction of the pin layer 33 does not change. Magnetic resistance changes depending on the angular difference between the spin direction of the pin layer 33 and the spin direction of the free layer 35. When a head-up bias voltage is applied to the read head HR, current I flowing into the read head HR varies depending on the change in the magnetic resistance. The playback signal detection unit 6B illustrated in FIG. 1 can subject the current I to filter amplification to detect a signal read by the read head HR.

When the spin direction of the pin layer 33 and the spin direction of the free layer 35 are the same, the magnetic resistance becomes minimum. When the spin direction of the pin layer 33 and the spin direction of the free layer 35 are opposite to each other, the magnetic resistance becomes maximum. By applying the hard bias HB to the pin layer 33, it is possible to suppress occurrence of beard-like noise (called Barkhausen noise) at the time of abrupt change in spin and allow the polarity of the leaked magnetic field to be determined.

The bottom shield 31 and the top shield 37 are provided in the down-track direction DE from the free layer 35. Accordingly, it is possible to prevent the leaked magnetic field from the burst patterns 23E in the down-track direction DE from being applied to the free layer 35. Meanwhile, the bottom shield 31 and the top shield 37 do not exist in the cross-track direction DC from the free layer 35. Accordingly, the leaked magnetic field from the burst patterns 23E in the cross-track direction DC is applied to the free layer 35. When the leaked magnetic field in the cross-track direction DC is applied unevenly to the read head HR, anti-parallel noise occurs.

As illustrated in FIGS. 5A, 5D, and 5E, the read head HR moves along the path TE in the down-track direction DE. At this time, the offset value OF1 of the read head HR is zero. In this case, when the read head HR moves on the N phase of the burst pattern 23, the vertical magnetic field J1 from the N phase of the burst pattern 23 is applied to the free layer 35, whereas a leaked magnetic field J2 from the burst pattern 23 in the cross-track direction DC is not applied to the free layer 35. Accordingly, as illustrated in the waveform LA2 of FIG. 5B, a playback amplitude according to the vertical magnetic field J1 from the N phase of the burst pattern 23 is detected by the head amplifier.

When the read head HR moves on the Q phase of the burst pattern 23, the vertical magnetic field J1 from the Q phase of the burst pattern 23 is not applied to the free layer 35. In this case, however, since the read head HR moves on the boundary between the N pole and the S pole, the leaked magnetic field J2 from the burst pattern 23 in the cross-track direction DC is applied to the free layer 35. Accordingly, as illustrated in the waveforms LB2 and LC2 of FIG. 5B, even though the vertical magnetic field J1 from the Q phase of the burst pattern 23 does not exist, the playback amplitude according to the leaked magnetic field J2 is detected by the head amplifier according to the positive or negative pole of the hard bias HB.

Meanwhile, as illustrated in FIGS. 5D and 5E, the read head HR moves along a path TE′ in the down-track direction DE. At this time, the offset value OF1 of the read head HR is smaller than zero. In this case, when the read head HR moves on the N phase of the burst pattern 23, a leaked magnetic field J2′ from the burst pattern 23 in the cross-track direction DC is applied to the free layer 35. When the read head HR moves on the Q phase of the burst pattern 23, a leaked magnetic field J2″ from the burst pattern 23 in the cross-track direction DC is applied to the free layer 35. Accordingly, the leaked magnetic fields J2, J2′, and J2″ applied to the free layer 35 in the cross-track direction DC change depending on the offset value OF1 of the read head HR. Therefore, the anti-parallel noise changes depending on the offset value OF1 of the read head HR.

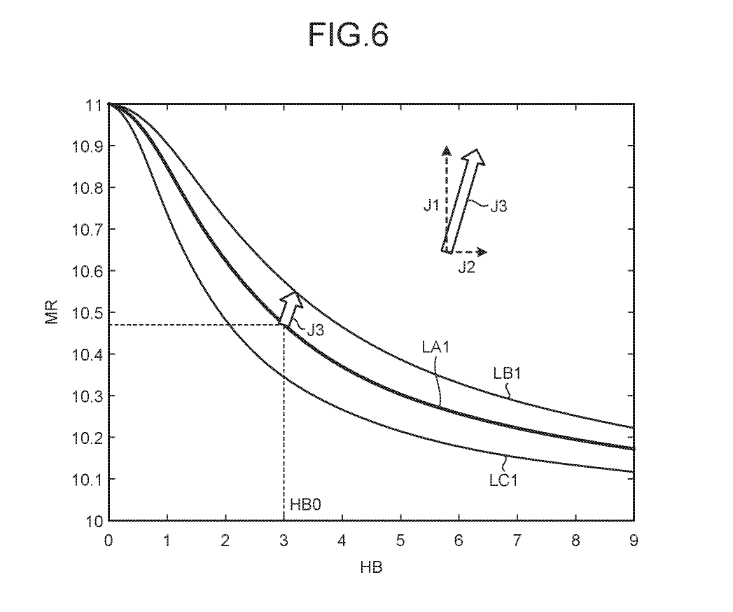

FIG. 6 is a diagram illustrating the relationships between hard bias and magnetic resistance of the magnetic disk device according to the first embodiment. In FIG. 6, LA1 indicates the relationship between the hard bias HB and the magnetic resistance MR without an external magnetic field J3, LB1 indicates the relationship between the hard bias HB and the magnetic resistance MR with the positive external magnetic field J3, LC1 indicates the relationship between the hard bias HB and the magnetic resistance MR with the negative external magnetic field J3. The external magnetic field J3 is a magnetic field formed by combining the vertical magnetic field J1 and the leaked magnetic field J2.

Referring to FIG. 6, the hard bias HB of the read head HR is set to HB0. At this time, when the leaked magnetic field J2 is not applied to the read head HR, the magnetic resistance MR changes only depending on the vertical magnetic field J1. Meanwhile, when the leaked magnetic field J2 is applied to the read head HR, the magnetic resistance MR changes depending on the external magnetic field J3 in an oblique direction. Accordingly, even though the vertical magnetic field J1 is zero, the magnetic resistance MR changes depending on the leaked magnetic field J2, and the leaked magnetic field J2 is detected. When the leaked magnetic field J2 is detected, anti-parallel noise occurs.

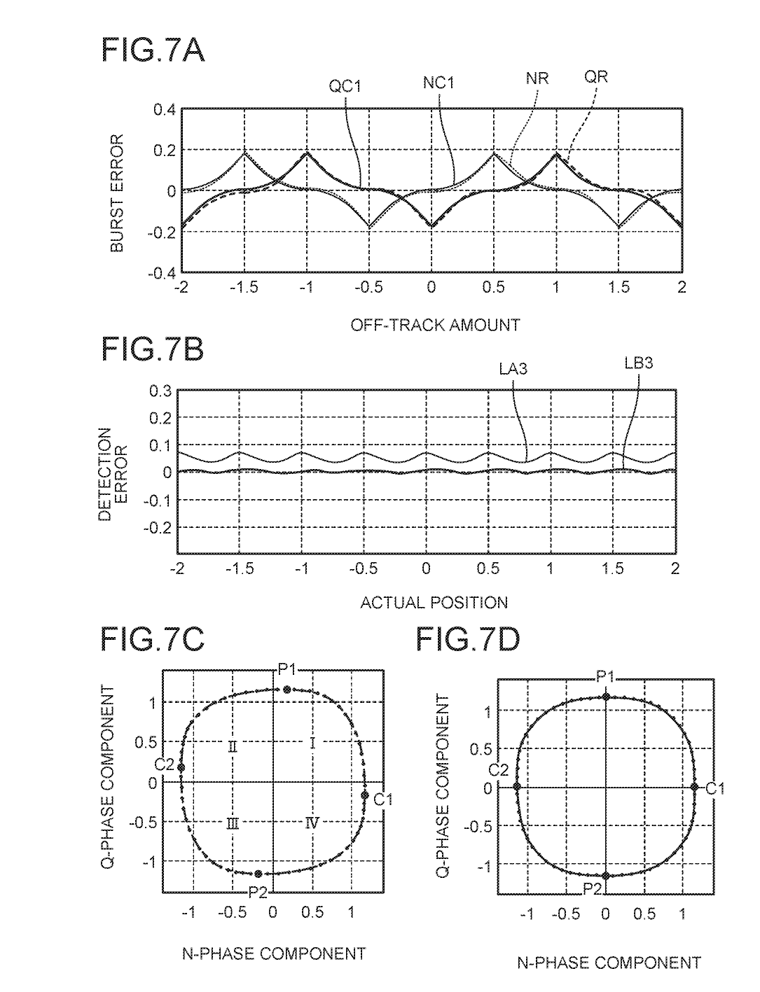

FIG. 7A is a diagram illustrating the relationship between off-track amount and burst error (anti-parallel noise) of the magnetic disk device according to the first embodiment, FIG. 7B is a diagram illustrating the relationship between actual position and detection error of the read head HR of the magnetic disk device according to the first embodiment, FIG. 7C is a diagram illustrating a position Lissajous figure of N-phase component and Q-phase component before bias correction of DFT arithmetic operation results of head output in the magnetic disk device according to the first embodiment, and FIG. 7D is a diagram illustrating a position Lissajous figure of N-phase component and Q-phase component after bias correction of DFT arithmetic operation results of head output in the magnetic disk device according to the first embodiment. In FIGS. 7C and 7D, the N-phase components correspond to an X axis, and the Q-phase components correspond to a Y axis. The same thing applies to all the following position Lissajous figures.

As the position Lissajous figure of N-phase component and Q-phase component before bias correction by the head bias correction unit 12 illustrated in FIG. 4, the curve deformed in a rectangular shape illustrated in FIG. 7C is obtained. The position Lissajous figure illustrated in FIG. 7C is rotated from the position where targets are arranged in a first quadrant I, a second quadrant II, a third quadrant III, and a fourth quadrant IV. At this time, servo centers C1 and C2 and servo boundaries P1 and P2 are shifted from the X axis and the Y axis. The rotation of the position Lissajous figure results from anti-parallel noise.

As illustrated in FIG. 7A, an N-phase noise pattern and a Q-phase noise pattern determined by simulation are given as NR and QR, respectively. At this time, the N-phase noise pattern NR and the Q-phase noise pattern QR are approximated by quadratic functions to obtain an N-phase noise pattern NC1 and a Q-phase noise pattern QC1. The N-phase noise pattern NC1 and the Q-phase noise pattern QC1 can be used for bias correction by the head bias correction unit 12. Arithmetic equations offN and offQ for the N-phase noise pattern NC1 and the Q-phase noise pattern QC1 in the first quadrant I, the second quadrant II, the third quadrant III, and the fourth quadrant IV can be given by the following equations where offtrk denotes the target offset value BF.
First quadrant I
   off=offtrk
   offN=−4*off²
   offQ=4*(off−0.5)²
Second quadrant II
   off=offtrk+0.5
   offN=−4*(off−0.5)²
   offQ=−4*off²
Third quadrant III
   off=offtrk
   offN=4*off²
   offQ=−4*(off−0.5)²
Fourth quadrant IV
   off=offtrk+0.5
   offN=4*(off−0.5)²
   offQ=4*off²

The head bias correction unit 12 illustrated in FIG. 4 makes bias correction based on the N-phase noise pattern NC1 and the Q-phase noise pattern QC1 illustrated in FIG. 7A to obtain the curve illustrated in FIG. 7D as a position Lissajous figure of N-phase component and Q-phase component. At this time, the correction values QC and NC can be determined from the values of the N-phase noise pattern NC1 and the Q-phase noise pattern QC1 in which the off-track amount takes the target offset value BF. In addition, the optimization coefficients Gb can be determined such that peaks in the N-phase noise pattern NC1 and the Q-phase noise pattern QC1 coincide with peaks in the anti-parallel noise. The position Lissajous figure illustrated in FIG. 7D is not rotated unlike the position Lissajous figure illustrated in FIG. 7C. In addition, the servo centers C1 and C2 and the servo boundaries P1 and P2 are arranged on the X axis and the Y axis.

As illustrated in FIG. 7B, the detection error of the off-track amount is LA3 before the bias correction by the head bias correction unit 12, whereas the detection error of the off-track amount is LB3 with reduction in detection error after the bias correction by the head bias correction unit 12. The standard deviation of the detection error of the off-track amount is 1.21% of the track pitch before the bias correction by the head bias correction unit 12, whereas it is 0.3% of the track pitch after the bias correction by the head bias correction unit 12.

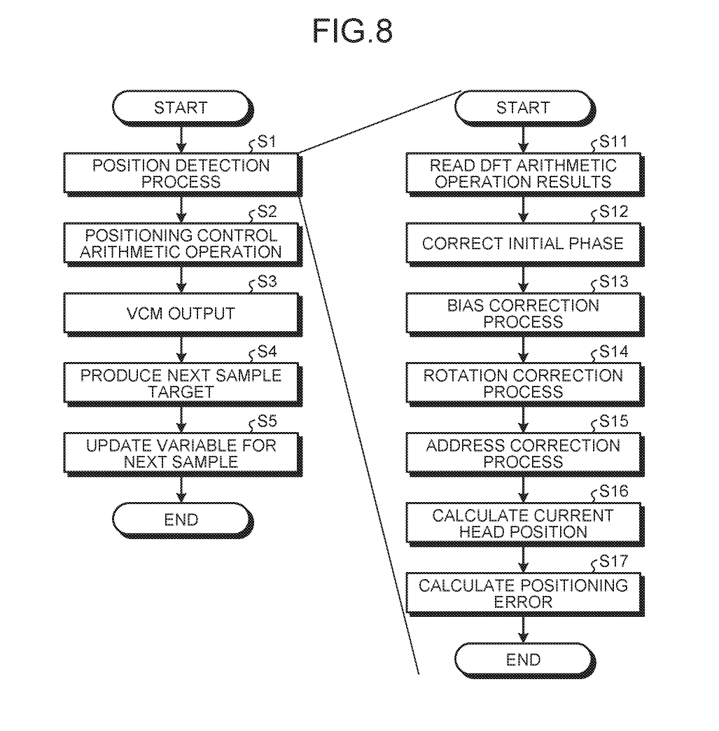

FIG. 8 is a flowchart of a servo interrupt process in the magnetic disk device according to the first embodiment.

Referring to FIG. 8, when a servo interrupt occurs, the position detection processing unit 9A illustrated in FIG. 1 performs a position detection process (S1). In the position detection process, the position detection processing unit 9A reads the results of DFT arithmetic operation from the read/write channel 8 (S11).

The initial phase correction unit 11 corrects an initial phase corresponding to the phase shift of the burst gate BG from the burst pattern 23 (S12).

The head bias correction unit 12 makes bias correction to the N-phase component BN1 and the Q-phase component BQ1 of the burst value (S13). At this time, it is possible to reduce the anti-parallel noise in the N-phase component BN1 and the Q-phase component BQ1 of the burst value.

The rotation correction unit 41 rotates the position Lissajous figure of the N-phase component BN2 and the Q-phase component BQ2 of the burst value corrected by the head bias correction unit 12 (S14).

The address correction unit 14 corrects the cylinder address value CA based on the N-phase component BN3 and the Q-phase component BQ3 of the burst value rotated by the rotation correction unit 41 (S15).

The offset value calculation unit 13 calculates the offset value OF2 based on the N-phase component BN3 and the Q-phase component BQ3 of the burst value rotated by the rotation correction unit 41 to determine the current position of the read head HR (S16). At the calculation of the offset value OF2, the N-phase component BN3 and the Q-phase component BQ3 of the burst value can be converted into an off-track amount from the servo center by an approximation process using a tan function.

The offset value calculation unit 13 determines the positioning error of the read head HR based on the offset value OF2 calculated by the offset value calculation unit 13 and the cylinder position information CPS (S17).

The hard disk control unit 9 performs a positioning control arithmetic operation of the read head HR based on the positioning error of the read head HR (S2), and controls driving of the voice coil motor 4 (S3).

The hard disk control unit 9 produces the target offset value BF for the next sample (S4), and updates the variable for the servo processing on the next sample (S5). At this time, the variable for the bias correction by the head bias correction unit 12 can also be updated.

### Second Embodiment

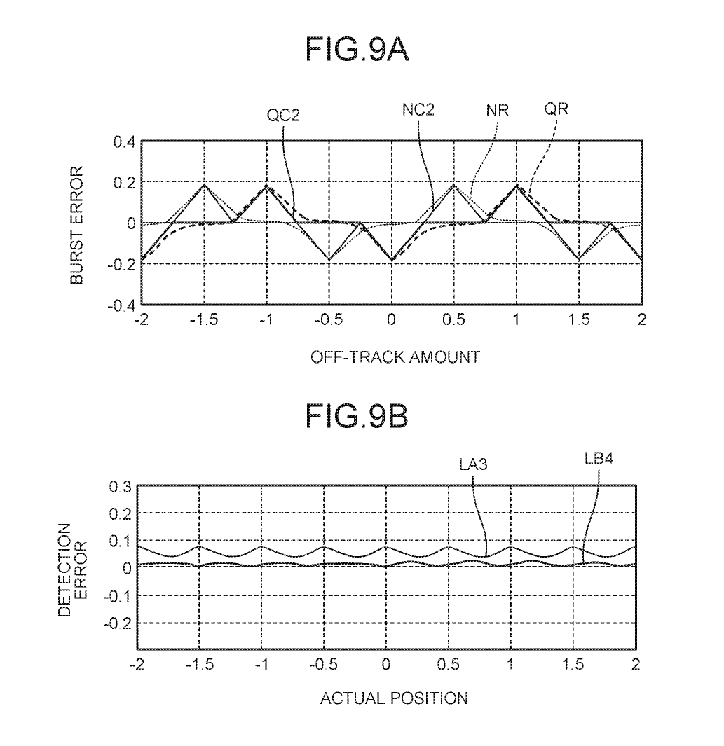

FIG. 9A is a diagram illustrating the relationship between off-track amount and burst error of a magnetic disk device according to a second embodiment, and FIG. 9B is a diagram illustrating the relationship between actual position and detection error of the read head HR of the magnetic disk device according to the second embodiment.

Referring to FIG. 9A, the N-phase noise pattern NR and the Q-phase noise pattern QR can be approximated by partial triangular waves to obtain an N-phase noise pattern NC2 and a Q-phase noise pattern QC2. The N-phase noise pattern NC2 and the Q-phase noise pattern QC2 can be used for bias correction by the head bias correction unit 12. In the N-phase noise pattern NC2, the off-track amount ranges of 0.25 to 0.75 and −1.25 to −1.75 are corrected by a positive triangular wave, and the off-track amount ranges of 1.25 to 1.75 and −0.25 to −0.75 are corrected by a negative triangular wave, and the other ranges are not corrected. In the Q-phase noise pattern QC2, the off-track amount ranges of 0.75 to 1.25 and −0.75 to −1.25 are corrected by a positive triangular wave, and the off-track amount range of 0.25 to −0.25 is corrected by a negative triangular wave, and the other ranges are not corrected. It is possible to reduce a calculation load by using the N-phase noise pattern NC2 and the Q-phase noise pattern QC2 for the bias correction by the head bias correction unit 12.

As illustrated in FIG. 9B, the detection error of the off-track amount is LA3 before the bias correction by the head bias correction unit 12, whereas the detection error of the off-track amount is LB4 after the bias correction by the head bias correction unit 12. At this time, the standard deviation of the detection error of the off-track amount is 1.21% of the track pitch before the bias correction by the head bias correction unit 12, whereas it is 0.41% of the track pitch after the bias correction by the head bias correction unit 12.

### Third Embodiment

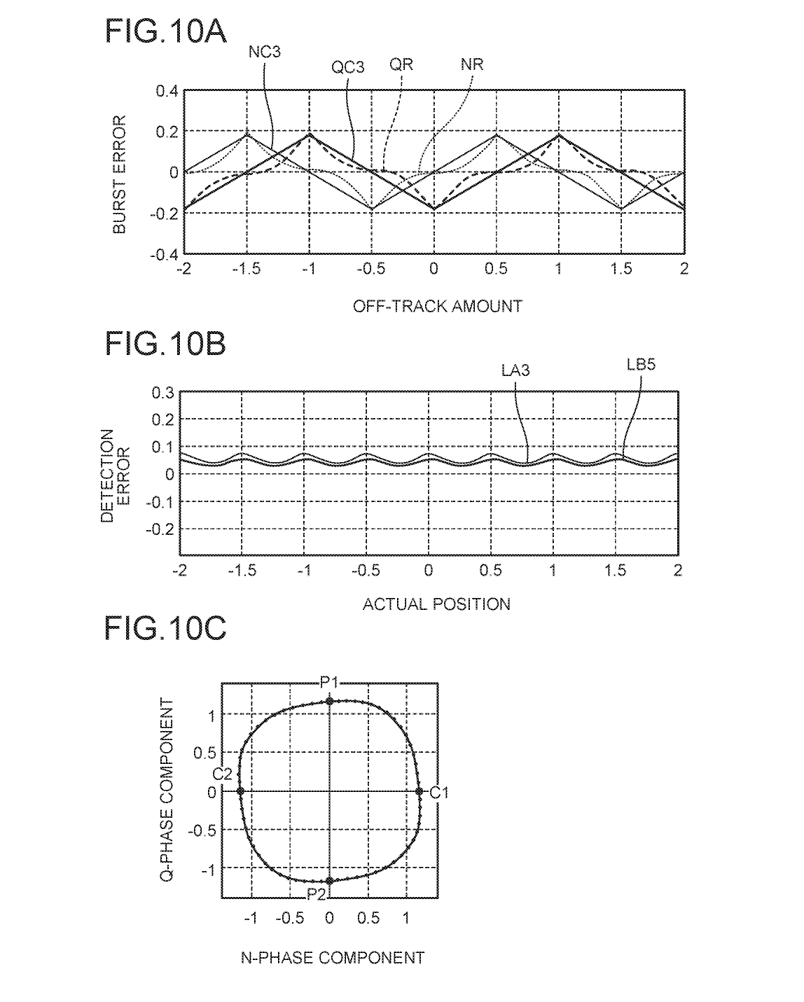

FIG. 10A is a diagram illustrating the relationship between off-track amount and burst error of a magnetic disk device according to a third embodiment, FIG. 10B is a diagram illustrating the relationship between actual position and detection error of the read head HR of the magnetic disk device according to the third embodiment, and FIG. 10C is a diagram illustrating a position Lissajous figure of N-phase component and Q-phase component after bias correction of DFT arithmetic operation results of head output in the magnetic disk device according to the third embodiment.

Referring to FIG. 10A, the N-phase noise pattern NR and the Q-phase noise pattern QR can be approximated by perfect triangular waves to obtain an N-phase noise pattern NC3 and a Q-phase noise pattern QC3. The N-phase noise pattern NC3 and the Q-phase noise pattern QC3 can be used for bias correction by the head bias correction unit 12. It is possible to reduce a calculation load by using the N-phase pattern NC3 and the Q-phase noise pattern QC3 for the bias correction by the head bias correction unit 12.

When the head bias correction unit 12 illustrated in FIG. 4 makes bias correction based on the N-phase noise pattern NC3 and the Q-phase noise pattern QC3 illustrated in FIG. 10A, the curve illustrated in FIG. 10C can be obtained as a position Lissajous figure of N-phase component and Q-phase component. According to the method using the N-phase noise pattern NC3 and the Q-phase noise pattern QC3 of FIG. 10A, the area on which no anti-parallel noise is superimposed is excessively corrected, and therefore the position Lissajous figure illustrated in FIG. 10C is still rotated.

As illustrated in FIG. 10B, the detection error of the off-track amount is LA3 before the bias correction by the head bias correction unit 12, whereas the detection error of the off-track amount is LB5 after the bias correction by the head bias correction unit 12.

Accordingly, when the optimization coefficients Gb are determined such that the peaks in the N-phase noise pattern NC3 and the Q-phase noise pattern QC3 coincide with the peaks in the anti-parallel noise, the effect of improving linearity at the position detection of the read head HR cannot be sufficiently obtained. At this time, the standard deviation of the detection error of the off-track amount is 1.21% of the track pitch before the bias correction by the head bias correction unit 12, whereas it is 0.69% of the track pitch after the bias correction by the head bias correction unit 12.

### Fourth Embodiment

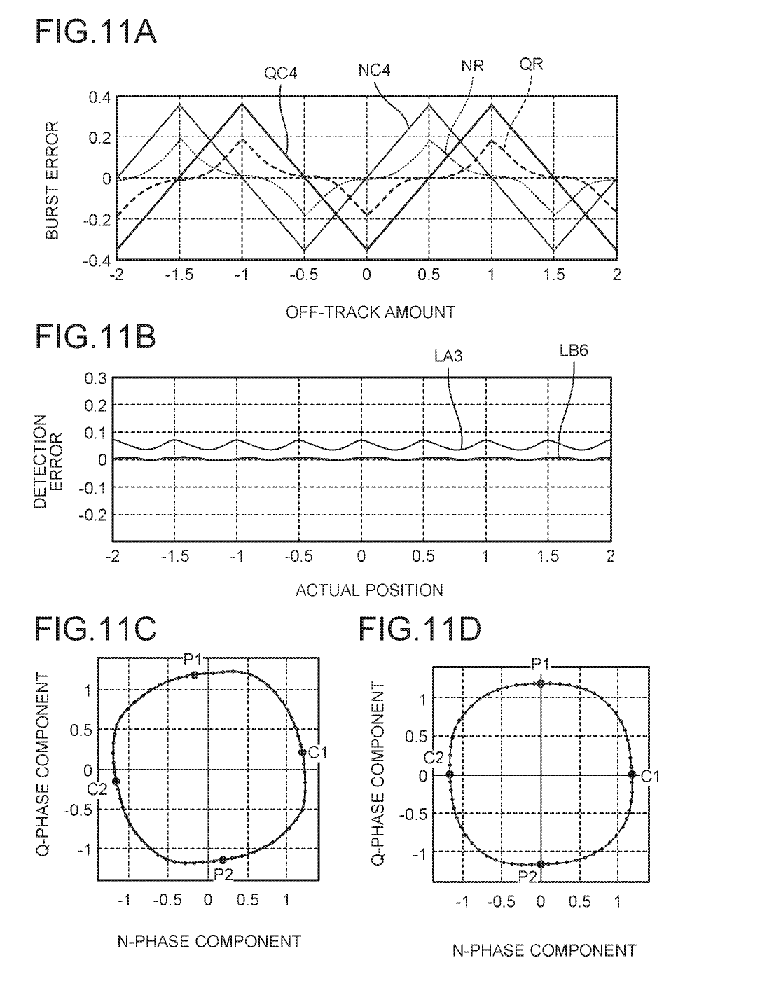

FIG. 11A is a diagram illustrating the relationship between off-track amount and burst error of a magnetic disk device according to a fourth embodiment, FIG. 11B is a diagram illustrating the relationship between actual position and detection error of the read head HR of the magnetic disk device according to the fourth embodiment, FIG. 11C is a diagram illustrating a position Lissajous figure of N-phase component and Q-phase component after bias correction of DFT arithmetic operation results of head output in the magnetic disk device according to the fourth embodiment, and FIG. 11D is a diagram illustrating a position Lissajous figure of N-phase component and Q-phase component after bias correction and rotation correction of DFT arithmetic operation results of head output in the magnetic disk device according to the fourth embodiment.

Referring to FIG. 11A, an N-phase noise pattern NR and a Q-phase noise pattern QR are approximated by perfect triangular waves to obtain an N-phase noise pattern NC4 and a Q-phase noise pattern QC4. The amplitudes of the N-phase noise pattern NC4 and the Q-phase noise pattern QC4 are twice those of the N-phase noise pattern NC3 and the Q-phase noise pattern QC3 illustrated in FIG. 10A. The N-phase noise pattern NC4 and the Q-phase noise pattern QC4 can be used for bias correction by the head bias correction unit 12. It is possible to reduce a calculation load by using the N-phase noise pattern NC4 and the Q-phase noise pattern QC4 for bias correction by the head bias correction unit 12.

When the head bias correction unit 12 illustrated in FIG. 4 makes bias correction based on the N-phase noise pattern NC4 and the Q-phase noise pattern QC4 illustrated in FIG. 11A, the curve illustrated in FIG. 11C can be obtained as a position Lissajous figure of N-phase component and Q-phase component. According to the method using the N-phase noise pattern NC4 and the Q-phase noise pattern QC4, bias correction is made in excess of the amount of influence of anti-parallel noise. Accordingly, the position Lissajous figure illustrated in FIG. 11C is more rotated as compared to the position Lissajous figure illustrated in FIG. 7C.

However, the area with a large signal strength of the burst value has a small distortion in the position Lissajous figure resulting from the rotational movement due to the SN ratio. Meanwhile, the area with a large distortion in the position Lissajous figure resulting from the rotational movement is corrected at the same inclination as that of the anti-parallel noise, and points in the position Lissajous figure are equally spaced. Accordingly, the position Lissajous figure illustrated in FIG. 11C is subjected to rotation correction to obtain the curve illustrated in FIG. 11D. The position Lissajous figure illustrated in FIG. 11D is not rotated unlike the position Lissajous figure illustrated in FIG. 7C. The servo centers C1 and C2 and the servo boundaries P1 and P2 are arranged on the X axis and the Y axis.

As illustrated in FIG. 11B, the detection error of the off-track amount is LA3 before the bias correction by the head bias correction unit 12, whereas the detection error of the off-track amount is LB6 when the rotation correction is made after the bias correction by the head bias correction unit 12. At this time, the standard deviation of the detection error of the off-track amount is 1.21% of the track pitch before the bias correction by the head bias correction unit 12, whereas it is 0.25% of the track pitch when the rotation correction is made after the bias correction by the head bias correction unit 12.

### Fifth Embodiment

In the embodiment described above, the head bias correction unit 12 makes the bias correction based on the relationship between the off-track amount of the read head HR and the burst error. However, a pseudo-offset may occur in positioning of the read head HR before the correction by the head bias correction unit 12. In the event of a pseudo-offset, no bias correction can be made to the true off-track position of the read head HR due to off-track characteristics of the read head HR.

In relation to the fifth embodiment, a bias offset identification process for making bias correction to the true off-track position of the read head HR will be described.

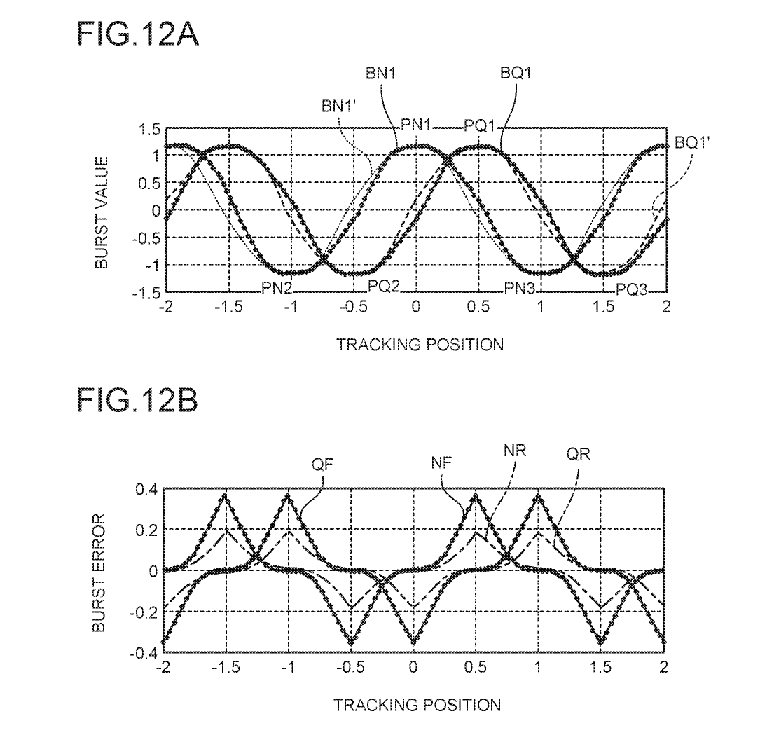

FIG. 12A is a diagram illustrating the relationship between tracking position and burst value applied to a bias offset identification process in a magnetic disk device according to the fifth embodiment, and FIG. 12B is a diagram illustrating the relationship between tracking position and burst error identified by the bias off-set identification process in the magnetic disk device according to the fifth embodiment.

Referring to FIG. 12A, the drawings of the relationships between the N-phase component BN1 and the Q-phase component BQ1 of the burst value and the tracking position are slightly left-right asymmetrical and are waveforms standing midway between a sin wave and a trapezoidal wave. It is difficult from the relationships to identify the shape and amplitude of anti-parallel noise relative to the off-track amount.

Accordingly, the N-phase component BN1 of the burst value is reversed horizontally around tracking positions having peaks PN1 to PN3 of the N-phase component BN1 of the burst value to produce an N-phase reverse component BN1′. The tracking positions having the peaks PN1 to PN3 correspond to the central positions of the N phase of the burst pattern 23. At the central positions of the N phase of the burst pattern 23, the magnetic field in the cross-track direction DC becomes symmetrical. Accordingly, it is considered that, at the tracking positions having the peaks PN1 to PN3, the magnetic field in the cross-track direction is canceled out and no anti-parallel noise occurs. Therefore, by reversing horizontally the N-phase component BN1 of the burst value around the tracking positions having the peaks PN1 to PN3, it is possible to emphasize a positioning distortion of the read head HR and represent emphatically the anti-parallel noise of the N-phase component BN1 of the burst value.

Similarly, the Q-phase component BQ1 of the burst value is reversed horizontally around tracking positions having peaks PQ1 to PQ3 of the Q-phase component BQ1 of the burst value to produce a Q-phase reverse component BQ1′. The tracking positions having the peaks PQ1 to PQ3 correspond to the central positions of the Q phase of the burst pattern 23. At the central positions of the Q phase of the burst pattern 23, the magnetic field in the cross-track direction DC becomes symmetrical. Accordingly, it is considered that, at the tracking positions having the peaks PQ1 to PQ3, the magnetic field in the cross-track direction is canceled out and no anti-parallel noise occurs. Therefore, by reversing horizontally the Q-phase component BQ1 of the burst value around the tracking positions having the peaks PQ1 to PQ3, it is possible to emphasize a positioning distortion of the read head HR and represent emphatically the anti-parallel noise of the Q-phase component BQ1 of the burst value.

As illustrated in FIG. 12B, the difference between the N-phase component BN1 and the N-phase reverse component BN1′ is taken at each tracking position to produce an N-phase noise pattern NF. Similarly, the difference between the Q-phase component BQ1 and the Q-phase reverse component BQ1′ to produce a Q-phase noise pattern QF. In the N-phase noise pattern NF and the Q-phase noise pattern QF, the doubled value of true anti-parallel noise determined by simulation can be represented. However, the shapes and peak positions of the anti-parallel noise represented by the N-phase noise pattern NF and the Q-phase noise pattern QF are slightly shifted from true values.

The head bias correction unit 12 illustrated in FIG. 4 can make bias correction based on the N-phase noise pattern NF and the Q-phase noise pattern QF illustrated in FIG. 12B. At this time, the optimization coefficients Gb can be determined from the N-phase noise pattern NF and the Q-phase noise pattern QF.

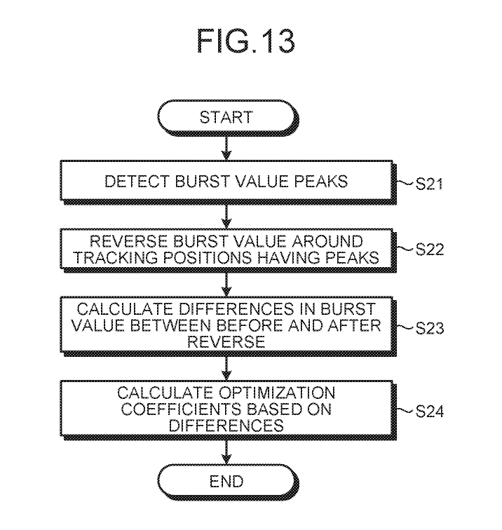

FIG. 13 is a flowchart of the bias offset identification process in the magnetic disk device according to the fifth embodiment.

Referring to FIG. 13, the peaks PN1 to PN3 of the N-phase component BN1 and the peaks PQ1 to PQ3 of the Q-phase component BQ1 of the burst value are detected (S21).

The N-phase component BN1 is reversed in the positive-negative direction around the tracking positions where the N-phase component BN1 of the burst value has the peaks PN1 to PN3, and the Q-phase component BQ1 is reversed in the positive-negative direction around the tracking positions where the Q-phase component BQ1 of the burst value has the peaks PQ1 to PQ3 (S22).

The differences in the N-phase component BN1 between before and after the reverse are calculated, and the differences in the Q-phase component BQ1 between before and after the reverse are calculated (S23).

The optimization coefficient Gb is determined with the difference between the maximum value and the minimum value of the differences in the N-phase component BN1 as ¼ of the inter-peak amplitude of the N-phase component BN1, and is stored in the memory. Similarly, the optimization coefficient Gb is determined with the difference between the maximum value and the minimum value of the differences in the Q-phase component BQ1 as ¼ of the inter-peak amplitude of the Q-phase component BQ1, and is stored in the memory (S24).

### Sixth Embodiment

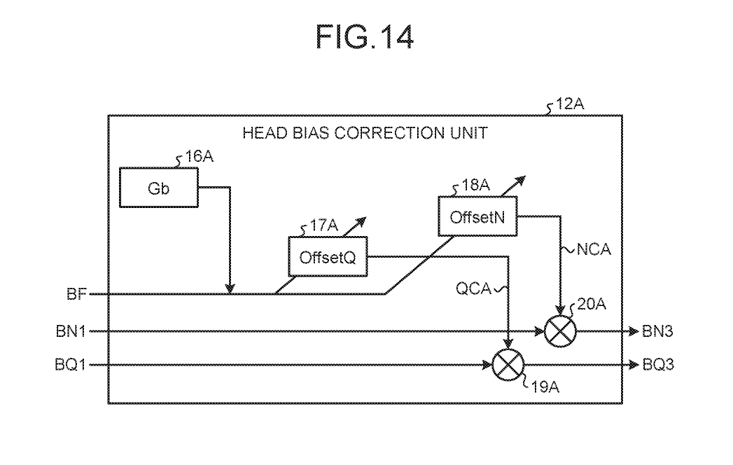

FIG. 14 is a schematic block diagram of a head bias correction unit of a magnetic disk device according to a sixth embodiment.

Referring to FIG. 14, a head bias correction unit 12A is provided with a coefficient output unit 16A, correction value calculation units 17A and 18A, and multipliers 19A and 20A. The head bias correction unit 12A can be used instead of the head bias correction unit 12 illustrated in FIG. 3. The correction value calculation unit 17A calculates a correction value QCA of the Q-phase component BQ1 from the target offset value BF. The correction value QCA can be calculated with reference to the gain-converted relationship between the off-track amount of the read head HR and the burst error of the Q-phase component BQ1 (hereinafter, this relationship will be referred to as Q-phase gain pattern). The correction value calculation unit 18A calculates a correction value NCA of the N-phase component BN1 from the target offset value BF. The correction value NCA can be calculated with reference to the gain-converted relationship between the off-track amount of the read head HR and the burst error of the N-phase component BN1 (hereinafter, this relationship will be referred to as N-phase gain pattern). The coefficient output unit 16A outputs the optimization coefficients Gb for optimization of the correction values QCA and NCA. The multiplier 19A multiplies the Q-phase component BQ1 by the correction value QCA. The multiplier 20A multiplies the N-phase component BN1 by the correction value NCA.

The correction value calculation unit 17A refers to the Q-phase gain pattern to determine a burst gain of the Q-phase component BQ1 corresponding to the target offset value BF. The correction value calculation unit 17A then multiplies the burst gain by the optimization coefficient Gb to calculate the correction value QCA of the Q-phase component BQ1. The multiplier 19A multiplies the Q-phase component BQ1 by the correction value QCA to calculate the Q-phase component BQ3.

The correction value calculation unit 18A refers to the N-phase gain pattern to determine a burst gain of the N-phase component BN1 corresponding to the target offset value BF. The correction value calculation unit 18A then multiplies the burst gain by the optimization coefficient Gb to calculate the correction value NCA of the N-phase component BN1. The multiplier 20A multiplies the N-phase component BN1 by the correction value NCA to calculate the N-phase component BN3.

By using the target offset value BF as the offset value OF1 illustrated in FIG. 3, it is possible to determine the correction values QCA and NCA without having to determine the offset value OF2. This improves the calculation accuracy of the offset value OF2 while suppressing the increase in the scale of the head bias correction unit 12A.

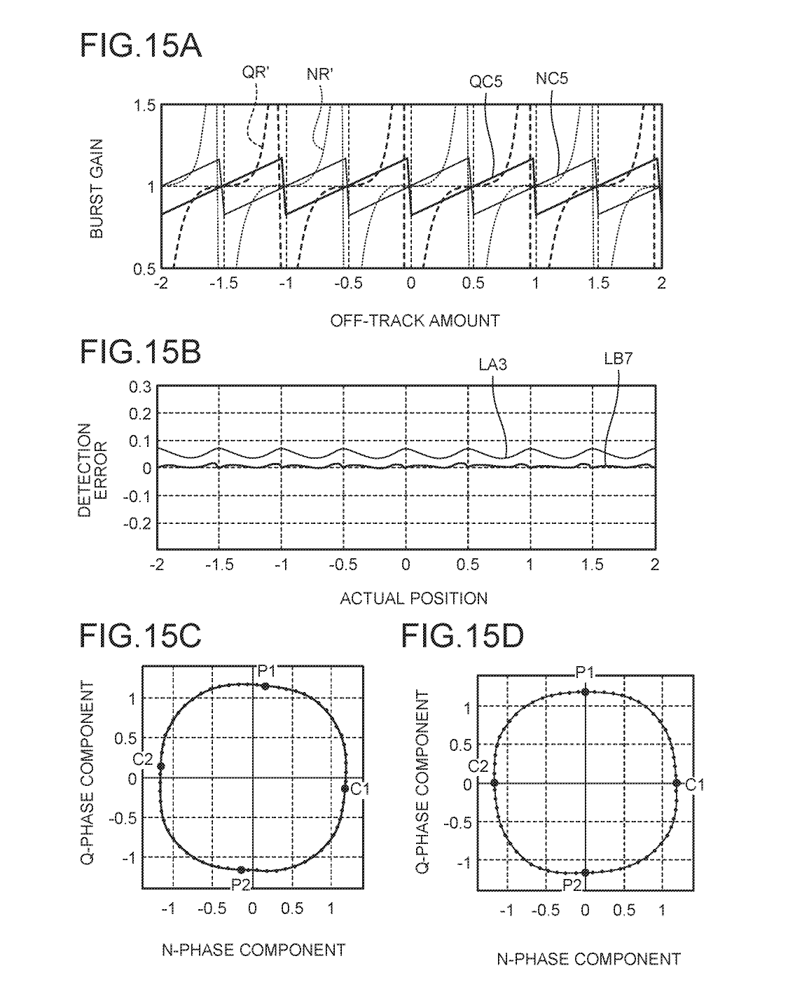

FIG. 15A is a diagram illustrating the relationship between off-track amount and burst gain of the magnetic disk device according to the sixth embodiment, FIG. 15B is a diagram illustrating the relationship between actual position and detection error of the read head HR of the magnetic disk device according to the sixth embodiment, FIG. 15C is a diagram illustrating a position Lissajous figure of N-phase component and Q-phase component after bias correction of DFT arithmetic operation results of head output in the magnetic disk device according to the sixth embodiment, and FIG. 15D is a diagram illustrating a position Lissajous figure of N-phase component and Q-phase component after adjustment of optimum coefficients at the time of bias correction of DFT arithmetic operation results of head output in the magnetic disk device according to the sixth embodiment. In FIG. 15A, NR′ and QR′ denote gain patterns in which the N-phase noise pattern NR and the Q-phase noise pattern QR illustrated in FIG. 7A are converted into gains.

Referring to FIG. 15A, the N-phase gain pattern NR′ and the Q-phase gain pattern QR′ are approximated by sawtooth waves to obtain an N-phase gain pattern NC5 and a Q-phase gain pattern QC5. In the N-phase gain pattern NC5 and the Q-phase gain pattern QC5, the averages of the burst gains can be set to one and the amplitudes can be set to one. The N-phase gain pattern NC5 and the Q-phase gain pattern QC5 can be used for bias correction by the head bias correction unit 12A. It is possible to reduce a calculation load by using the N-phase gain pattern NC5 and the Q-phase gain pattern QC5 for bias correction by the head bias correction unit 12A.

The head bias correction unit 12A illustrated in FIG. 14 makes bias correction based on the N-phase gain pattern NC5 and the Q-phase gain pattern QC5 illustrated in FIG. 15A to obtain the curve illustrated in FIG. 15C as a position Lissajous figure of N-phase component and Q-phase component. In addition, the head bias correction unit 12A adjusts the optimization coefficients Gb in the position Lissajous figure illustrated in FIG. 15C such that there is a match in inclination when anti-parallel noise is converted into gain to obtain the curve illustrated in FIG. 15D. The position Lissajous figure illustrated in FIG. 15D is not rotated unlike the position Lissajous figure illustrated in FIG. 7C. In addition, the servo centers C1 and C2 and the servo boundaries P1 and P2 are arranged on the X axis and the Y axis.

As illustrated in FIG. 15B, the detection error of the off-track amount is LA3 before the bias correction by the head bias correction unit 12A, whereas the detection error of the off-track amount is LB7 after the bias correction by the head bias correction unit 12A. At this time, the standard deviation of the detection error of the off-track amount is 1.21% of the track pitch before the bias correction by the head bias correction unit 12A, whereas it is 0.42% of the track pitch after the bias correction by the head bias correction unit 12A.

### Seventh Embodiment

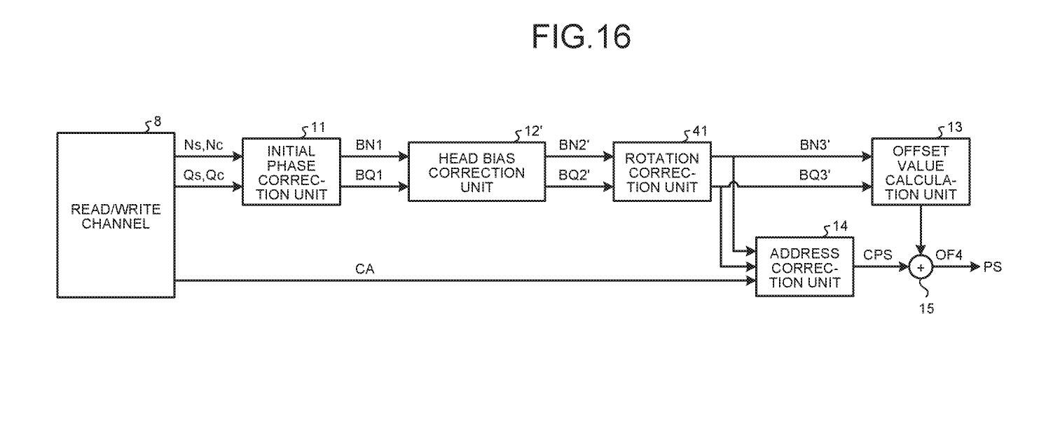

FIG. 16 is a schematic block diagram of a position detection processing unit of a magnetic disk device according to a seventh embodiment.

In the configuration of FIG. 16, a head bias correction unit 12′ is provided instead of the head bias correction unit 12 illustrated in FIG. 3. The head bias correction unit 12′ can use a tentative offset value PF instead of the target offset value BF. To calculate the tentative offset value PF, an offset value calculated by the offset value calculation unit 13 when the head bias correction unit 12′ does not make bias correction can be used.

The head bias correction unit 12′ corrects the N-phase component BN1 and the Q-phase component BQ1 to an N-phase component BN2′ and a Q-phase component BQ2′ based on the tentative offset value PF. The rotation correction unit 41 rotates a position Lissajous figure of the N-phase component BN2′ and the Q-phase component BQ2′ of the burst value corrected by the head bias correction unit 12′ to produce an N-phase component BN3′ and a Q-phase component BQ3′ of the burst value. The offset value calculation unit 13 calculates an offset value OF4 based on the N-phase component BN3′ and the Q-phase component BQ3′ of the burst value.

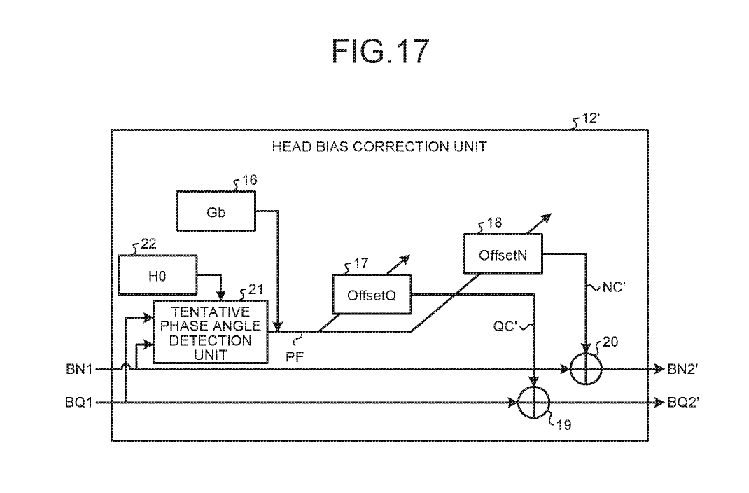

FIG. 17 is a schematic block diagram of the head bias correction unit illustrated in FIG. 16.

The head bias correction unit 12′ illustrated in FIG. 17 is configured such that a coefficient output unit 22 and a tentative phase angle detection unit 21 are added to the head bias correction unit 12 illustrated in FIG. 4. The tentative phase angle detection unit 21 calculates the tentative offset value PF based on the N-phase component BN1 and the Q-phase component BQ1 of the burst value. The tentative phase angle detection unit 21 can be provided with components similar to the initial phase correction unit 11, the rotation correction unit 41, and the offset value calculation unit 13. The coefficient output unit 22 outputs an optimization coefficient HO for optimization of the tentative offset value PF. The coefficient output unit 22 may not be necessarily provided.

The tentative phase angle detection unit 21 calculates the tentative offset value PF from the N-phase component BN1 and the Q-phase component BQ1 of the burst value. By dividing the phase angle calculated by the tentative phase angle detection unit 21 by the optimization coefficient HO, it is possible to correct an offset from the reference position at the phase angle. The optimization coefficient HO can be determined from the result of a simulation that the servo centers C1 and C2 and the servo boundaries P1 and P2 are arranged on the X axis and the Y axis by reversing the sign of the rotation angle by the rotation angle of the position Lissajous figure determined from the N-phase component BN1 and the Q-phase component BQ1.

The correction value calculation unit 17 refers to the Q-phase noise pattern to determine the burst error of the Q-phase component BQ1 corresponding to the tentative offset value PF. The correction value calculation unit 17 then multiplies the burst error by the optimization coefficient Gb to calculate a correction value QC′ of the Q-phase component BQ1. The adder 19 adds the correction value QC′ to the Q-phase component BQ1 to calculate the Q-phase component BQ2′.

The correction value calculation unit 18 refers to the N-phase noise pattern to determine the burst error of the N-phase component BN1 corresponding to the tentative offset value PF. The correction value calculation unit 18 then multiplies the burst error by the optimization coefficient Gb to calculate a correction value NC′ of the N-phase component BN1. The adder 20 adds the correction value NC′ to the N-phase component BN1 to calculate the N-phase component BN2′.

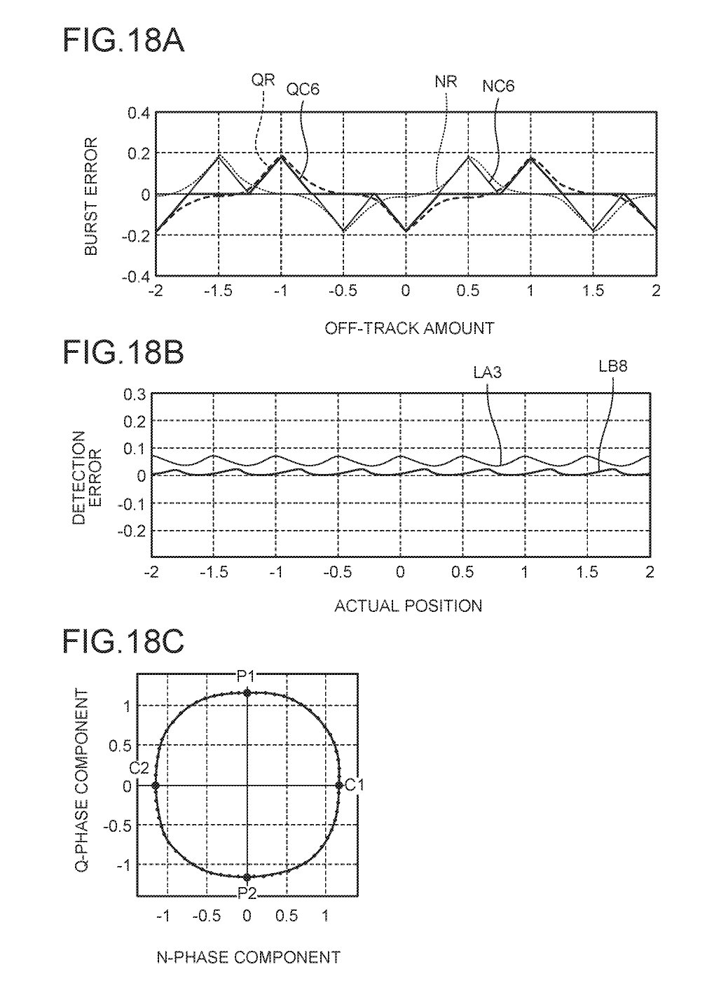

FIG. 18A is a diagram illustrating the relationship between off-track amount and burst error of the magnetic disk device according to the seventh embodiment, FIG. 18B is a diagram illustrating the relationship between actual position and detection error of the read head HR of the magnetic disk device according to the seventh embodiment, and FIG. 18C is a diagram illustrating a position Lissajous figure of N-phase component and Q-phase component after bias correction of DFT arithmetic operation results of head output in the magnetic disk device according to the seventh embodiment. Referring to FIG. 18A, as in the case of FIG. 9A, the N-phase noise pattern NR and the Q-phase noise pattern QR are approximated by partial triangular waves to obtain an N-phase noise pattern NC6 and a Q-phase noise pattern QC6. The N-phase noise pattern NC6 and the Q-phase noise pattern QC6 can be used for bias correction by the head bias correction unit 12′. It is possible to reduce a calculation load by using the N-phase noise pattern NC6 and the Q-phase noise pattern QC6 for bias correction by the head bias correction unit 12′.

The head bias correction unit 12′ illustrated in FIG. 17 makes bias correction based on the N-phase noise pattern NC1 and the Q-phase noise pattern QC1 illustrated in FIG. 7A to obtain the curve illustrated in FIG. 18C as a position Lissajous figure of N-phase component and Q-phase component. The position Lissajous figure illustrated in FIG. 18C is not rotated unlike the position Lissajous figure illustrated in FIG. 7C. In addition, the servo centers C1 and C2 and the servo boundaries P1 and P2 are arranged on the X axis and the Y axis.

As illustrated in FIG. 18B, the detection error of the off-track amount is LA3 before the bias correction by the head bias correction unit 12′, whereas the detection error of the off-track amount is LB8 with reduction in detection error after the bias correction by the head bias correction unit 12′.

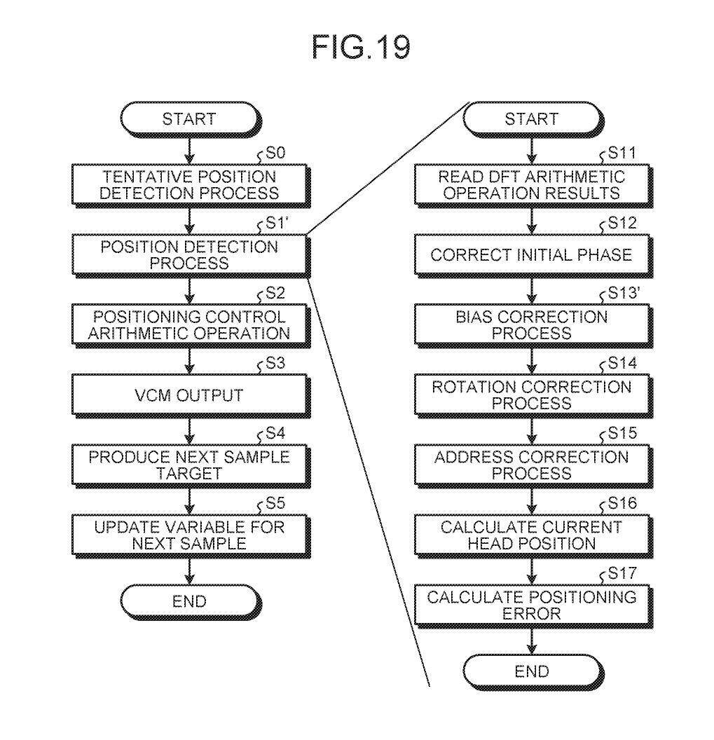

FIG. 19 is a flowchart of a servo interrupt process in the magnetic disk device according to the seventh embodiment.

In the servo interrupt process described in FIG. 19, tentative position detection process (S0) is added to the servo interrupt process described in FIG. 8. At the tentative position detection process (S0), reading of the DFT arithmetic operation results (S11), initial phase correction (S12), rotation correction (S14), address correction (S14), and current head position calculation (S16) described in FIG. 8 are carried out. At the current head position calculation (S16) of the tentative position detection process (S0), the tentative offset value PF described in FIG. 17 is calculated.

Upon completion of the tentative position detection process (S0), the process moves to position detection process (S1′). At the position detection process (S1′), bias correction (S13′) is carried out instead of the bias correction (S13) of the position detection process (S1) described in FIG. 8. At the bias correction described in FIG. 8 (S13), the target offset value BF is used as the offset value OF1. At the bias correction (S13′) described in FIG. 19, the tentative offset value PF is used as the offset value OF1. The error of the offset value OF1 can be reduced by using the tentative offset value PF instead of the target offset value BF.

In the seventh embodiment described above, as illustrated in FIG. 9A, the N-phase noise pattern NC2 and the Q-phase noise pattern QC2 obtained through the approximation of the N-phase noise pattern NR and the Q-phase noise pattern QR by partial triangular waves are used for bias correction. Instead of this, as illustrated in FIG. 7A, the N-phase noise pattern NC1 and the Q-phase noise pattern QC1 obtained through approximation of the N-phase noise pattern NR and the Q-phase noise pattern QR by the quadratic functions may be used for bias correction. Alternatively, as illustrated in FIG. 11A, the N-phase noise pattern NC4 and the Q-phase noise pattern QC4 obtained through approximation of the N phase noise pattern NR and the Q phase noise pattern QR by perfect triangular waves may be used for bias correction.

The head bias correction unit 12′ uses the tentative offset value PF instead of the target offset value BF of the head bias correction unit 12 illustrated in FIG. 4. Alternatively, the head bias correction unit 12′ may use the tentative offset value PF instead of the target offset value BF of the head bias correction unit 12A illustrated in FIG. 14.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A head position detecting method comprising:
reading, by a magnetic head, burst patterns arranged on a magnetic disk in a down-track direction such that phases in a cross-track direction are alternate while moving over the burst patterns;
generating a burst value from the results of reading of the burst patterns by the magnetic head; and
correcting a noise component appearing in the burst value resulting from a magnetic field applied in the cross-track direction at the time of reading of the burst patterns, wherein
the burst patterns include an N-phase burst pattern and a Q-phase burst pattern,
in the N-phase burst pattern and the Q-phase burst pattern, magnetized patterns are arranged such that the polarities are alternately reversed at phase intervals of 180 degrees in the cross-track direction and the phases are shifted from each other by 90 degrees in the cross-track direction,
the noise component appearing in an N-phase component obtained from the N-phase burst pattern and the noise component appearing in a Q-phase component obtained from the Q-phase burst pattern are independently corrected,
a correction value of the noise component is calculated based on an offset value as a position gap of the magnetic head from the center of the burst patterns in the cross-track direction,
correction values of the noise components appearing in the N-phase component and the Q-phase component are calculated in synchronization with the phases of arrangements of the burst patterns, and
phases of the correction values of the noise components appearing in the N-phase component and the Q-phase component are shifted from each other by 90 degrees.

2. The head position detecting method of claim 1, wherein the offset value is set based on a target offset value of the magnetic head.

3. The head position detecting method of claim 1, wherein the offset value is set based on a tentative offset value determined from the burst value before the correction of the noise component.

4. The head position detecting method of claim 1, wherein a burst error corresponding to the offset value is determined from the relationship between burst error with the noise component approximated and off-track amount, and a correction value obtained by multiplying the burst error by a coefficient is added to the burst value.

5. The head position detecting method of claim 1, wherein a burst gain corresponding to the offset value is determined from the relationship between burst gain as a gain-converted burst error with the noise component approximated and off-track amount, and the burst value is multiplied by a correction value obtained by multiplying the burst gain by a coefficient.

6. The head position detecting method of claim 3, wherein the correction value is determined based on characteristics obtained by simulating the relationship between off-track amount of the magnetic head and burst error corresponding to the off-track amount by a quadratic function, a triangular wave, or a sawtooth wave.

7. The head position detecting method of claim 1, wherein the relationship between the burst error with the noise component approximated and the off-track amount is determined based on the difference in the burst value between before and after the reverse of the burst value around a tracking position at which the burst value corresponding to the off-track amount of the magnetic head has a peak.

8. A magnetic disk device, comprising:
a magnetic head;
a magnetic disk in which burst patterns different in phase from each other in a cross-track direction are recorded in a down-track direction; and
a correction unit that corrects a burst value obtained from the results of reading of the burst patterns by the magnetic head, wherein
the burst patterns include an N-phase burst pattern and a Q-phase burst pattern,
in the N-phase burst pattern and the Q-phase burst pattern, magnetized patterns are arranged such that the polarities are alternately reversed at phase intervals of 180 degrees in the cross-track direction and the phases are shifted from each other by 90 degrees in the cross-track direction,
when correcting a noise component appearing in the burst value resulting from a magnetic field applied in the cross-track direction at the time of reading of the burst patterns, the correction unit corrects independently the noise component appearing in an N-phase component obtained from the N-phase burst pattern and the noise component appearing in a Q-phase component obtained from the Q-phase burst pattern,
the correction unit includes a calculation unit that calculates a correction value for correcting the noise component,
the calculation unit calculates the correction value based on an offset value as a position gap of the magnetic head from the center of the burst patterns in the cross-track direction,
correction values of the noise components appearing in the N-phase component and the Q-phase component are calculated in synchronization with the phases of arrangements of the burst patterns, and
phases of the correction values of the noise components appearing in the N-phase component and the O-phase component are shifted from each other by 90 degrees.

9. The magnetic disk device of claim 8, wherein the offset value is set based on a target offset value of the magnetic head.

10. The magnetic disk device of claim 8, wherein the offset value is set based on a tentative offset value determined from the burst value before the correction of the noise component.

11. The magnetic disk device of claim 8, wherein
the correction unit includes a first adder that adds up the burst value and the correction value, and
the correction value is a value obtained by determining a burst error corresponding to the offset value from the relationship between burst error with the noise component approximated and the off-track amount and multiplying the burst error by a coefficient.

12. The magnetic disk device of claim 8, wherein
the correction unit includes a multiplier that multiplies the burst value and the correction value, and
the correction value is a value obtained by determining a burst gain corresponding to the offset value from the relationship between burst gain as a gain-converted burst error with the noise component approximated and off-track amount and multiplying the burst gain by a coefficient.

13. The magnetic disk device of claim 8, wherein the offset value is determined based on characteristics obtained by simulating the relationship between off-track amount of the magnetic head and burst error corresponding to the off-track amount by a quadratic function, a triangular wave, or a sawtooth wave.

14. The magnetic disk device of claim 8, wherein the relationship between the burst error with the noise component approximated and the off-track amount is determined based on the difference in the burst value between before and after the reverse of the burst value around a tracking position at which the burst value corresponding to the off-track amount of the magnetic head has a peak.
